(19) United States
(12) Patent Application Publication
(10) Pub. No.: US 2026/0087543 A1
(43) Pub. Date: Mar. 26, 2026

(54) SUPPLY CHAIN AUTOMATION PLATFORM

(71) Applicant: Bank of America Corporation, Charlotte, NC (US)

(72) Inventors: Gregory Barrett, Charlotte, NC (US); Rachel A. Lauck, Scranton, PA (US); Duncan Edward Lodge, London (GB); Elizabeth Prudden Souffrant, Charlotte, NC (US); Lesley Roxe McNamara, New York, NY (US); Mark D. Zanzot, Charlotte, NC (US); Teela Yung, Los Angeles, CA (US); Madhav Goparaju, Chicago, IL (US); Hiro O. Atsumi, New York, NY (US)

(21) Appl. No.: 19/332,189

(22) Filed: Sep. 18, 2025

Related U.S. Application Data
(60) Provisional application No. 63/699,195, filed on Sep. 26, 2024.

(51) Int. Cl. G06Q 30/0601; G06Q 20/10; G06Q 20/28; G06Q 40/12

(52) U.S. Cl. CPC G06Q 30/0637; G06Q 20/10; G06Q 20/28; G06Q 40/12

(57) ABSTRACT

Systems, methods, and apparatus are provided for actuating an executable file based on data derived from a set of documents.

A first processor associated with a user account may receive input of a first document having a first format and a second document having a second format. The second format may be different from the first format. A second processor associated with the user account may receive an executable file in a standardized format including a set of parameters derived from the first document and the second document. Based on the set of parameters, the second processor may automatically trigger execution of the file.

### BACKGROUND OF THE DISCLOSURE

An open account trade is a sale arrangement between a buyer and a supplier. Goods may be shipped and delivered before payment is due. The buyer may agree to pay the supplier at a specified date.

The paperwork involved in an open account trade is extensive and involves many different parties, each with their own proprietary system. In some cases, a buyer with a complex global supply chain may outsource elements of the invoice approval process to a service provider, particularly in the case of cross-border imports.

The service provider must obtain a full range of invoices and documents from logistics providers. A purchase order must be compared to the correct invoice data and reviewed to identify any discrepancies. Discrepancies are typically remediated between the buyer, service provider, and supplier via email, phone, and mail. Payment must be manually scheduled for the invoice maturity date.

It would be desirable to integrate buyers, suppliers, logistics providers, and financial institutions at a single standardized digital platform. It would be desirable to digitally match purchase orders with invoices and logistics documents and digitally remediate discrepancies.

It would further be desirable to create a nexus for buyers to harness the speed and efficiency of the platform through their home financial institution. Such an arrangement may enable a financial institution to seamlessly integrate purchasing, invoice approval, financing, and automate payment services for their clients.

### SUMMARY OF THE DISCLOSURE

Systems, methods, and apparatus are provided for actuating an executable file.

A first processor may include a user interface associated with an account. The first processor may receive input of a first document having a first format. The first processor may receive input of a second document having a second format. The second format may be different from the first format.

A second processor associated with the account may receive an executable file in a standardized format. In some embodiments, the executable file may be a payment file. The executable file may include a set of parameters derived from the first document and the second document. The second processor may automatically trigger execution of the file based on the set of parameters.

The first document and the second document may be transmitted to a remote third processor. The executable file may be received from the remote third processor. The third processor may not be associated with the account.

In some embodiments, input of the first document and the second document may be received from a first user. The set of parameters may further be based on a third document received from another user. The third document may have a format that is different from the first document and from the second document. Execution of the file may include a transfer of funds between the users.

In response to execution of the file, the second processor may generate a dataset associated with a payment and automatically transmit the dataset to a user associated with the first document and the second document. The first processor may reconcile the dataset with existing account data.

In some embodiments, the set of parameters may include a maturity date. The maturity date may trigger execution of the file. In some embodiments, the first processor may receive an input approving an early payment option and the second processor may initiate a payment before the maturity date. The payment may be funded by a financial institution associated with the account.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative process flow in accordance with principles of the disclosure;

FIG. 4 shows an illustrative process flow in accordance with principles of the disclosure;

FIG. 5 shows an illustrative process flow in accordance with principles of the disclosure; and

FIG. 6 shows an illustrative process flow in accordance with principles of the disclosure.

### DETAILED DESCRIPTION

Systems, methods, and apparatus are provided for an integrated supply chain automation platform.

Open account transactions typically involve significant paperwork. Illustrative paperwork may include a purchase order, commercial invoice, production certificate, bill of lading, waybill, packing list, certificate of origin, forwarder's cargo receipt, arrival notice, and customs clearance. These documents may be generated by a range of parties including buyers, suppliers, service providers, logistics providers, and customs agents. The documents may have different formats that may be proprietary to each party. The documents for any particular transaction may be all digital documents, all physical documents, or a mix of physical and digital documents.

Conventionally, payment may be manually scheduled by the buyer in response to manual approval of an invoice. Manual approval may be based on a comparison of the invoice to the purchase order, as well as information from logistics providers regarding shipping and arrival, along with any other suitable considerations.

It would be desirable to onboard buyers, suppliers, and logistics suppliers to an integrated platform configured to automatically capture and standardize digital document data, electronically match purchase orders and invoices, and digitally reconcile discrepancies.

A standardized digital open account platform may provide a faster, simpler way for clients to manage their open account trade. The digital platform may be a self-service platform that is available at any time.

The platform may use cloud technology to facilitate near real-time exchanges of information between parties. Digital data matching may be faster and more accurate than manual review and may reduce the time required for invoice matching and approval from weeks to hours. Parties may also use the platform to resolve detected discrepancies digitally, within the platform.

The platform may be integrated with financial institution payment processing (ACH or wire) enabling automated payment and reconciliation. Improvements in payment processing may in turn improve supplier relationships and support the health of the suppliers through early payment. The streamlined payment protocols may further unlock procure-to-pay benefits for the buyer, maximizing procurement and financing efficiency.

For suppliers, the platform may offer rapid on-boarding using automated supplier verification. Automated supplier verification may accelerate the onboarding process while also providing confidence for buyers.

The platform may improve cash flow for suppliers by reducing sales days outstanding. The integrated platform may also allow suppliers to access a wider network of buyers and interact directly with multiple new buyers.

The platform may enable a buyer to integrate its financial account, contract information, and physical supply chain data at a single platform. A financial institution associated with the buyer may use this information to generate insights for the buyer global supply chain.

The platform may use distributed ledger technology to ensure the integrity of the documents and provide efficient storage.

The platform may be provided as a tool for buyers through a financial institution platform. The financial institution may be a bank. The buyer may have a pre-existing relationship with the bank as a bank client. The bank may onboard a buyer by providing the tool as a product or service through a new or existing client channel.

In some embodiments, the buyer may preselect rules and tolerances, upload documents, and submit approvals through bank channels. The buyer may receive communications regarding invoice approval or resolution of discrepancies through bank channels. Platform operations, including integration with suppliers, rule-based document matching, and discrepancy resolution, may be backend operations that are screened from the buyer.

Providing access to platform automation tools through a client bank account may broaden the payment options available, benefiting both buyers and suppliers. For example, the preexisting bank relationship with a client may enable the bank to offer an early payment option to the supplier, with the bank funding the early payment through an extension of credit to the buyer.

Providing access to platform automation tools through a client bank account may also improve adoption. The platform may require participation by buyers, suppliers, and logistics providers. Historically, arranging participation by disparate parties, each with their own proprietary open account protocols and document formats, has limited widespread access to the efficiencies obtained by an integrated digital platform. Onboarding buyers through their existing relationships with a financial institution may enable broader adoption. Suppliers wanting to work with this large block of buyers may become adopters as well.

The platform may receive a set of uploads. The uploads may include a purchase order from the buyer. The purchase order may be available to the supplier. The supplier may ship goods or provide services to the buyer based on the purchase order. The supplier and/or an associated logistics provider may submit documentation against the purchase order. The uploads may include digitized versions of physical documents. Such documents may include a purchase order, commercial invoice, production certificate, bill of lading, waybill, packing list, certificate of origin, forwarder's cargo receipt and arrival notice.

The platform may capture data from documents uploaded by the buyer, supplier, and/or logistics supplier. The platform may extract data or metadata from the digitized documents. The platform may reformat or standardize data or metadata. The platform may use one more artificial intelligence or machine learning (AI/ML) algorithms to identify and reformat data. The platform may use AI machine vision algorithms for advanced image analysis.

The platform may include a rules engine. The rules engine may auto-match a purchase order with an invoice and/or associated logistics data. The auto-match may be based on rules selected and/or modified by the buyer. The auto-match may be based on rule tolerances selected and/or modified by the buyer. The platform may use one or more AI/ML algorithms to match documents. The AI/ML algorithms may use feedback from rule engine output to auto-tune the rule tolerances and auto-select rules to refine the output.

The platform may detect a discrepancy between auto-matched documents. The platform may enable digital resolution within the platform. Resolution may include notifying the parties, providing the parties with selectable options, and/or any suitable resolution. In response to auto-matching, the platform may generate an approved invoice. The platform may use one or more AI/ML algorithms to detect discrepancies and/or generate options for resolution.

The platform may communicate with a buyer's bank to facilitate payment of an approved invoice. In some embodiments, the platform may include an option to initiate payment from a buyer account at the maturity date for the invoice. The option to initiate payment at the maturity date may be a default option. The platform may include an option for early payment. The option may be selected by a supplier. The early payment may be financed by the buyer's bank, based on its relationship with the buyer. The buyer's bank may receive an executable file bank for automated payment at the maturity date or the early payment date.

The features of the integrated supply chain automation platform may be applied to improve a range of technical fields. The standardization layer combined with the prebuilt open platform may be adapted to address technical challenges involved in connecting supply chain data with investment and financing solutions.

The platform may implement an embedded financing program. The platform may capture and standardize a range of business documents. Standardizing and centralizing document data on the processing platform may provide additional options for participants.

The platform may enable a financial institution to aggregate and unlock data to provide analysis for customers. The analysis may be in the form of a report or any suitable format. Invoice data and payment data that are matched by the platform may be used by a financial institution to provide customers with insights into their working capital. For example, the financial institution may provide customers with a more accurate cash position. The financial institution may provide customers with a risk distribution based on history associated with their transaction partners. Based on existing relationships, the financial institution may provide connectivity to new markets or service providers.

The financial institution may access the platform to create a marketplace for investors. Using aspects of the analysis, the platform may implement receivable securitization protocols to package data uploaded to the platform for investors. The financial institution may process platform data to generate broader financing opportunities for all the parties. For example, based on the documentation, the financial institution may create a short-term loan and then package the loan on the backend to sell to the investor community.

A standardized platform interface and secure mechanism for ingestion of data under the umbrella of a financial institution may encourage broad adoption, which in turn may expand system capabilities to connect more parties and provide global solutions.

The platform may be customized for different industries. For example, in the healthcare industry, the platform may be configured to interface with individual providers, HMOs and provider groups, hospitals and other institutions, patients, guarantors, financial institutions, insurance companies, and any other suitable parties.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

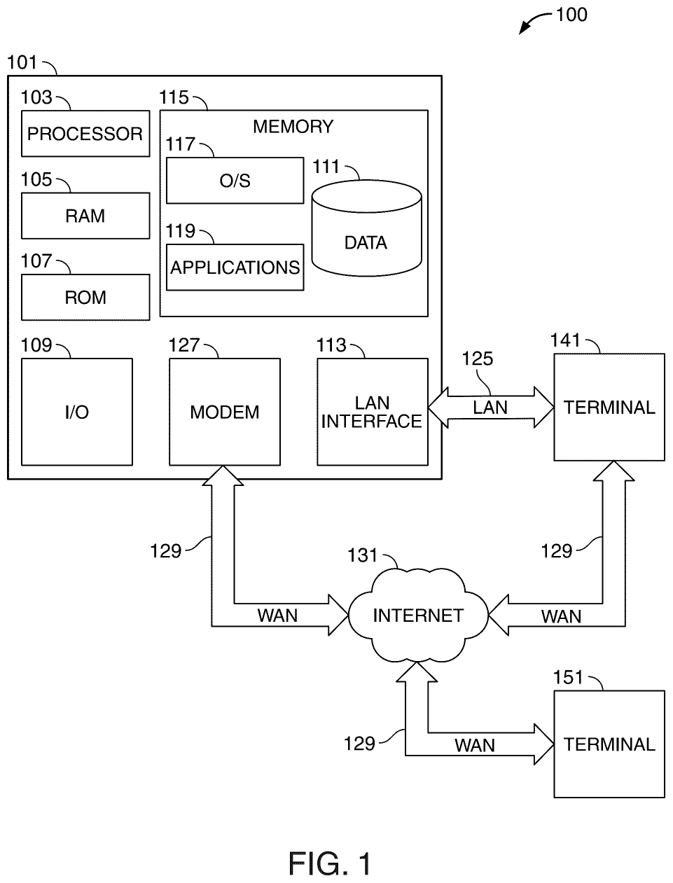

FIG. 1 shows an illustrative block diagram of system 100 that includes computer 101. Computer 101 may alternatively be referred to herein as an “engine,” “server,” or a “computing device. ” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

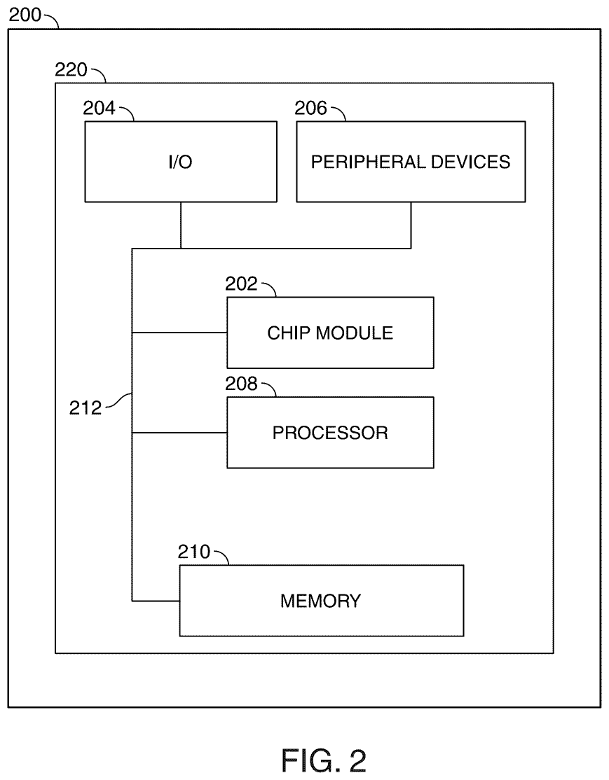

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

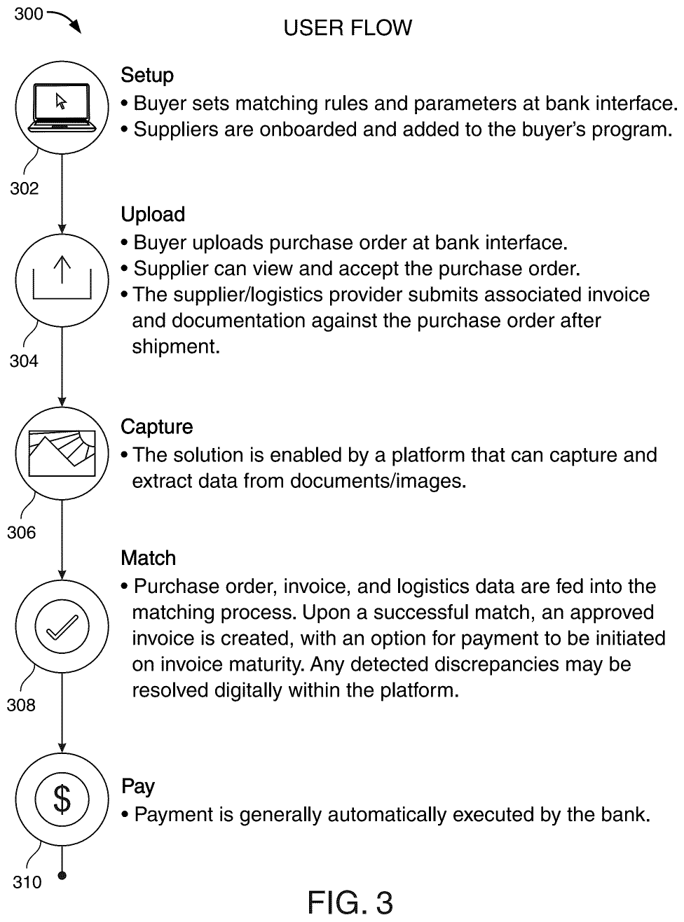

FIG. 3 shows illustrative process flow 300 for an integrated supply chain automation platform. At 302, a buyer may be a bank client. The buyer may interact with a bank interface to set rules for matching documents. Suppliers may be onboarded to the platform at a separate interface provided by the platform. Suppliers may be associated with a buyer profile or account.

At 304, the buyer may upload a purchase order at the bank interface. The bank may move the upload through the platform for viewing by the supplier. The supplier may view and accept the purchase order. The supplier and any logistics providers associated with the purchase may upload an invoice and other documentation after shipment. For example, a logistics provider may be a shipper and may upload a waybill, an arrival confirmation, or a customs clearance.

At 306, the platform may capture and extract data from uploaded documents and images. The platform may use one or more AI/ML algorithms to parse documents and to identify and standardize data. The platform may format data and/or metadata to enable matching a purchase order to other documents.

At 308, a rules engine associated with the platform may match the purchase order with invoice and logistics data and generate an approved invoice. The rules engine may detect discrepancies which may be resolved digitally within the platform. The approved invoice may include a default option for automatic initiation of payment from the buyer's bank at a due date associated with the invoice. At 310, payment is automatically executed by the buyer's bank.

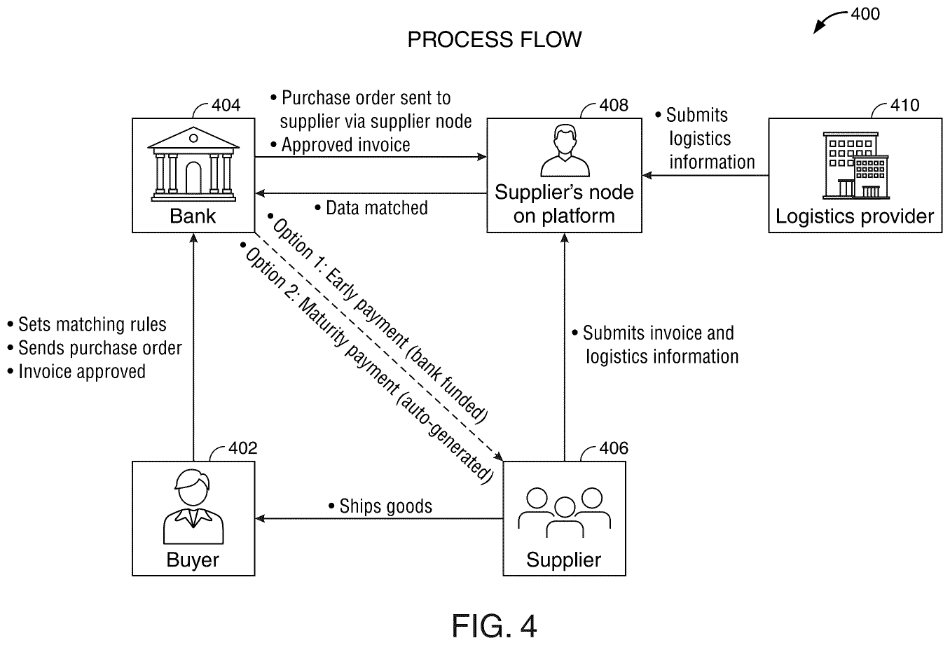

FIG. 4 shows illustrative process flow 400 for an integrated supply chain automation platform. Buyer 402 may interact with a bank interface to perform actions such as setting matching rules, uploading purchase orders, and approving invoices. Bank 404 may implement the platform for the buyer. At the platform, a purchase order from the buyer may be sent to a supplier node and documents uploaded by the buyer may be matched by a rules engine to documents uploaded by suppliers and logistics providers. Bank 404 may execute payment to the supplier.

Supplier 406 may ship goods to the buyer. Supplier 406 may upload invoices and logistics information to supplier node 408 on the platform. Logistics provider 410 may upload additional logistics information to the platform. For example, supplier 406 may upload a contract with a shipper and logistics provider 410 may upload a notice of arrival.

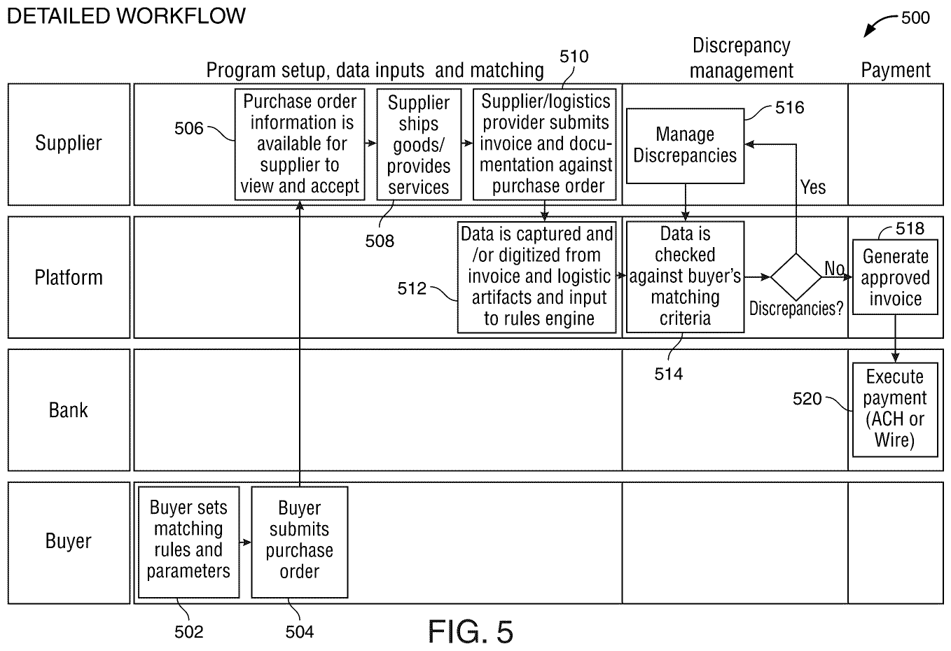

FIG. 5 shows illustrative process flow 500 for an integrated supply chain automation platform. At 502, a buyer may set matching parameters at a bank interface. At 504, the buyer may submit a purchase order at the bank interface. The bank may facilitate upload to the platform. At 506, the purchase order information may be available at the platform for the supplier to view and accept. At 508, the supplier may ship goods or provide services to the buyer.

At 510, the supplier and a logistics provider may submit invoices and documentation associated with the purchase order to the platform. The platform may capture and extract data from the uploaded artifacts and input standardized data to the rules engine.

At 514, the platform may check the data against the matching parameters set by the buyer. If discrepancies between matched documents exist, at 516, they may be managed digitally through the platform. If the match is acceptable, at 518, the platform may generate an approved invoice. At 520, the bank may execute payment for the invoice.

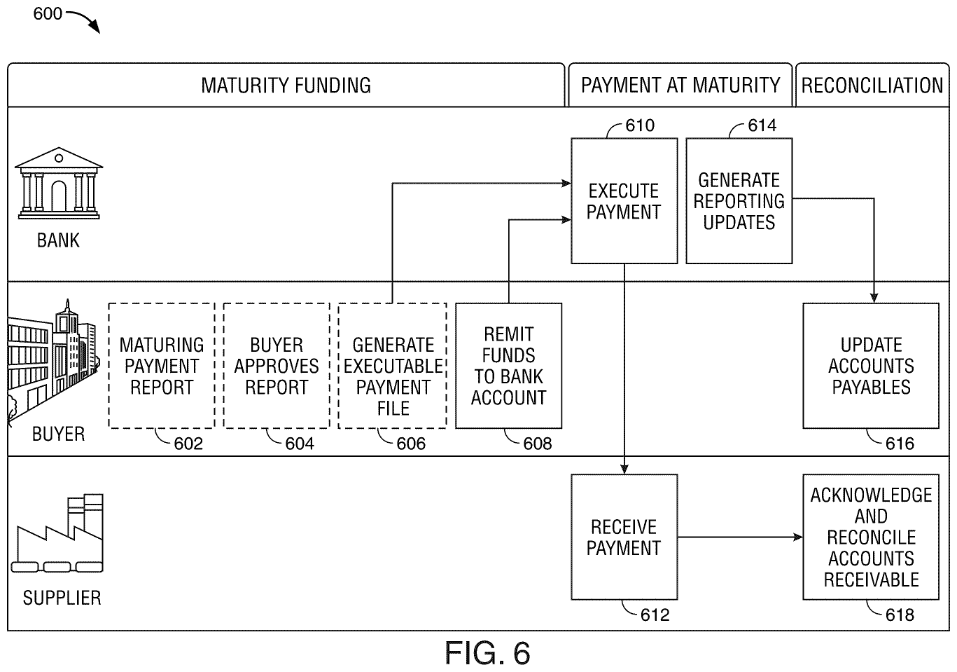

FIG. 6 shows illustrative process flow 600 for an executable payment file. Financial institutions systems may automatically execute a payment file that is based on parameters derived from invoices and other documents input by various parties and processed at the integrated platform.

In process flow 600, boxes with broken lines may represent steps occurring at the integrated platform or at remote interfaces associated with a buyer or seller. Boxes with solid lines may represent steps at a system associated with a user financial institution account.

Steps 602-608 may involve maturity funding. At 602, the integrated platform may generate a report detailing maturing payments for a buyer. The report may include the gross amount for payments due on a given day. The report may cover an upcoming period of twenty-one days, one week, one month, or any suitable time period. At 604, the buyer may approve the report at a buyer interface. In some embodiments, the buyer may approve the report at a front-end interface associated with a financial institution. At 606, the integrated platform may generate an executable payment file for an invoice payment that is coming due.

The executable payment file may have a standardized format. The executable payment file may have an ISO 20022 file format or any suitable format. ISO 20022 format is a standardized communication framework for global financial systems. The executable file may include parameters determined from documents received at the integrated platform. For example, the parameters may include a payment date. The payment date may be based on an invoice maturity date, a shipping date, a delivery date, or any other suitable date.

At 608, the buyer may remit funds in advance of the maturity date. The buyer may interact with a front-end interface associated with a financial institution to remit funds.

Steps 610-614 may involve execution of the payment file. At 610, financial institution systems may automatically execute the payment file. The execution may be triggered by the maturity date or by any suitable file parameter. At 612, a supplier may access the payment at a front-end interface associated with a financial institution. At 614, financial institution systems may generate reporting updates based on the executed payment.

Steps 616-618 may involve systems for payment reconciliation. At 616, accounts payable data for a buyer may be updated at a front-end interface associated with a financial institution based on the executed payment. At 618, accounts receivable data for a supplier may be updated at a front-end interface associated with a financial institution based on the executed payment.

Thus, methods and apparatus for an INTEGRATED SUPPLY CHAIN AUTOMATION PLATFORM are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for actuating an executable file, the method comprising:
at a first processor comprising a front-end interface associated with an account:
receiving input of a first document having a first format; and
receiving input of a second document having a second format, the second format different from the first format; and
at a second processor comprising a back-end interface associated with the account:
receiving an executable file in a standardized format, the executable file comprising a set of parameters based on the first document and the second document; and
based on the set of parameters, automatically triggering execution of the file.

2. The method of claim 1 further comprising transmitting the first document and the second document to a remote third processor and receiving the executable file from the remote third processor.

3. The method of claim 1, wherein:
input of the first document and the second document is received from a first party;
the set of parameters is further based on receiving input of a third document from a second party, the third document having a format different from the first document and the second document; and
execution of the file comprises a transfer of funds from the first party to the second party.

4. The method of claim 1, further comprising, in response to execution of the file:
at the back-end interface:
generating a first dataset associated with a payment; and
automatically transmitting the first dataset to a party associated with the first document and the second document; and
at the front-end interface, reconciling the first dataset with a second dataset associated with the account.

5. The method of claim 1, wherein the set of parameters comprises an execution date.

6. The method of claim 5, further comprising:
at the front-end interface, receiving an input approving an early payment option; and
at the back-end interface, initiating a payment before the execution date, the payment funded by a financial institution associated with the account.

7. The method of claim 1, further comprising, at the front-end interface, receiving an input approving content of the executable file.

8. A system for actuating an executable file based on data derived from a set of documents, the system comprising:
a first processor associated with a user account and configured to:
receive input of a first document having a first format; and
receive input of a second document having a second format, the second format different from the first format; and
a second processor associated with the user account and configured to:
receive an executable file in a standardized format, the executable file comprising a set of parameters based on the first document and the second document; and
based on the set of parameters, automatically trigger execution of the file.

9. The system of claim 8, further comprising a third processor that is not associated with the account configured to:
receive the first document and the second document from the first processor; and
transmit the executable file to the second processor.

10. The system of claim 8, wherein:
input of the first document and the second document is received from a first party;
the set of parameters is further based on receiving input of a third document from a second party, the third document having a format different from the first document and the second document; and
execution of the file comprises a transfer of funds from the first party to the second party.

11. The system of claim 8, wherein in response to execution of the file:
the second processor is configured to:
generate a first dataset associated with a payment; and
automatically transmit the first dataset to a party associated with the first document and the second document; and
the first processor is configured to reconcile the first dataset with a second dataset associated with the user account.

12. The system of claim 8, wherein the set of parameters comprises an execution date.

13. The system of claim 12, wherein:
the first processor is further configured to receive an input approving an early payment option; and
in response to the input, the second processor is further configured to initiate a payment before the execution date, the payment funded by a financial institution associated with the user account.

14. The system of claim 8, the first processor further configured to receive an input approving content of the executable file.

15. One or more non-transitory computer-readable media storing computer-executable instructions which, when executed by a processor on a computer system, perform a method for actuating an executable file, the method comprising:
at a first processor comprising a user interface associated with an account:
receiving input of a first document having a first format; and
receiving input of a second document having a second format, the second format different from the first format; and
at a second processor associated with the account:
receiving an executable file in a standardized format, the file comprising a set of parameters based on the first document and the second document; and
based on the set of parameters, automatically triggering execution of the file.

16. The media of claim 15, further comprising transmitting the first document and the second document to a remote third processor and receiving the executable file from the remote third processor.

17. The media of claim 15, wherein:
input of the first document and the second document is received from a first user;
the set of parameters is further based on receiving input of a third document from a second user, the third document having a format different from the first document and the second document; and
execution of the file comprises a transfer of funds from the first user to the second user.

18. The media of claim 15, further comprising, in response to execution of the file:
at the second processor:
generating a first dataset associated with a payment; and
automatically transmitting the first dataset to a user associated with the first document and the second document; and
at the first processor, reconciling the first dataset with a second dataset associated with the account.

19. The media of claim 15, wherein the set of parameters comprises an execution date.

20. The media of claim 19, further comprising:
at the first processor, receiving an input approving an early payment option; and
at the second processor, initiating a payment before the execution date, the payment funded by a financial institution associated with the account.
